(19) United States
(12) Patent Application Publication
(10) Pub. No.: US 2009/0077935 A1
(43) Pub. Date: Mar. 26, 2009

(54) QUADRUPED ANIMAL HARNESS

(76) Inventor: Timothy William Forster, New South Wales (AU)

Correspondence Address: BROOKS KUSHMAN P.C., 1000 TOWN CENTER, TWENTY-SECOND FLOOR, SOUTHFIELD, MI, 48075, US

(21) Appl. No.: 11/722,738

(22) PCT Filed: Dec. 23, 2005
(86) PCT No.: PCT/AU05/01957

§ 371 Date: Jun. 25, 2007

(30) Foreign Application Priority Data
Dec. 24, 2004 (AU) 2004907344

(51) Int. Cl. A01K 15/02; B68B 1/00

(52) U.S. Cl. 54/71; 119/793; 119/712

(57) ABSTRACT

A quadruped animal harness (10) has a back pad (12) adapted to be supported at a predetermined position on the back of the quadruped animal. There is also a rump strap (14) connected to a rear end of the pad and adapted to extend around the rump of the quadruped animal, a chest strap (16) connected to a front end of the pad and adapted to extend around the chest of the quadruped animal, a girth strap (18) connected to opposed sides of the pad and adapted to extend around the girth of the quadruped animal, and a connector strap (20) interconnecting the chest strap to the girth strap. A handle (22) is connected to the back pad. In use, the back pad is maintained at the predetermined position by the arrangement of the straps so as to enable a person to control and manipulate the quadruped animal when gripping the handle.

### FIELD OF THE INVENTION

The present invention relates to a quadruped animal harness and, in particular, to a harness with a spinal handle for postnatal handling and training of a foal or young horse.

The invention will be hereinafter described with reference its application to foals and young horses, although it is to be understood by persons skilled in the art that the invention also may have application to a range of “imprinting” or learning experience activities for other young equine animals and quadruped animals generally. It is also to be understood that the invention has application to a broad range of learning experience activities including, but not limited to, administering medication in the form of injections, worming, and drenching, as well as to foot trimming, microchip insertion, monitoring body functions, ophthalmology, and dentistry.

### BACKGROUND OF THE INVENTION

Foals born in captivity should ideally be handled at an early age with experiences that will ensure their ease of handling as they grow. These include desensitising the foal to the presence and physical manipulation of people, and to the wearing of saddles, girths, breastplates, tail and rump ropes, and harnesses, as well as to teaching the foal to lead, stop, move sideways and carry out other disciplined movements, such as may be required when a person escorts a horse onto a horse float. Handling should begin occurring as soon as possible after birth and from which a behaviour pattern is established. From this early training, information is absorbed with great speed and permanence.

Traditionally, foal handling is performed through a head collar and in a crush or stable, which compounds the normal risk of injury to foal or handler.

The harness of the present invention has particular application in the field of administering medication and other materials to the foal, such as administering oral paste for worm treatment, and ointments for treatment of eye punctures and ulcerations, as well as inserting microchips for long term monitoring purposes. Feet trimming (to correct any crookedness in the legs) is another field in which the invention has application.

Many of the aforementioned activities have typically been carried out by two people, one to calm and, if need be, restrain the foal and the other to, say, apply the saddle or administer the medication. Inexperienced people and a feisty or temperamental foal risk being injured during these activities.

Furthermore, the foal, as it grows, may develop poor behaviour and uneasiness when being handled if the aforementioned activities are not properly conducted at an early age.

It has now been found by the present inventor that a foal can be effectively and safely handled at an early age with a range of learning experience activities by use of a harness that fastens around the foal's torso and includes a top handle along the spine area that allows a person to control and manipulate the foal.

### OBJECT AND SUMMARY OF THE INVENTION

It is an object of the present invention to provide such a harness, and overcome, or at least substantially ameliorate, the disadvantages and shortcomings of the prior art.

According to the invention, there is provided a quadruped animal harness comprising a back pad adapted to be supported at a predetermined position on the back of the quadruped animal, a rump strap connected to a rear end of the pad and adapted to extend around the rump of the quadruped animal, a chest strap connected to a front end of the pad and adapted to extend around the chest of the quadruped animal, a girth strap connected to opposed sides of the pad and adapted to extend around the girth of the quadruped animal, a connector strap interconnecting the chest strap to the girth strap, and a handle connected to the back pad, the arrangement of the straps being such that, in use, the back pad is maintained at the predetermined position to enable a person to control and manipulate the quadruped animal when gripping the handle.

Preferably, the handle is aligned with the spine of the quadruped animal.

In a preferred form, the girth strap has a first part that is fixedly connected at a first end thereof to one side of the back pad and has a second end thereof to which is connected a first buckle component, the girth strap also having a second part that is elastically connected at a first end thereof to an opposite side of the back pad and has a second end thereof to which is connected a second buckle component, the first and second buckle components being adapted to interengage.

It is preferred that the handle is made of flexible material.

The handle may also be made of firm material.

### BRIEF DESCRIPTION OF THE DRAWING FIGURES

FIG. 1 is a side elevational view of a quadruped animal harness according to a preferred embodiment of the present invention.

FIG. 2 is a top view of a quadruped animal harness according to another preferred embodiment of the present invention.

FIG. 3 is a side view of a foal upon which the harness of FIG. 2 is fitted.

### BEST MODE AND OTHER EMBODIMENTS OF THE INVENTION

The harness 10 shown in the Figures is adapted for use with foals and includes a back pad 12, a rump strap 14, a chest strap 16, a girth strap 18, a connector strap 20, and a flexible handle 22.

The back pad 12, which in this instance is rectangular in shape, is sufficiently flexible to be supported over a central area of the back of the foal, and the handle 22 is connected, say, by metal rivets 24, to a central part of the back pad and aligned with the spine of the foal. In this embodiment, the back pad 12 is made of leather and has a felt underlay.

Connected to a rear end of the back pad 12 is the rump strap 14 which is of sufficient length to extend around the rump of the foal. The rump strap 14 is, in this instance, made of a neoprene or polyester webbing but may alternatively be made of leather. The rump strap 14 is made in two interconnectable parts, a longer length part 26 and a shorter length part 28. One end of the longer length part 26 of the rump strap 14 is fixedly connected by rivets or stitching to one rear corner region of the back pad 12. Secured at the other rear corner region is one end of the shorter length part 28 which terminates in a female buckle component 30. The female buckle component 30 is adapted to engage a male buckle component 32 connected to the free end of the longer length part 26 of the rump strap 14. The tightness of the rump strap 14 (when the female and male buckle components 30, 32 are interengaged) around the foal's rump may be adjusted by changing the location of the male buckle component 32 along the longer length part 26.

Connected to the front end of the back pad 12 is the chest strap 16 which is of sufficient length to extend around the chest or breast of the foal. The chest strap 16 may be made in a similar manner to the rump strap.

Connected to opposed sides of the back pad 12 is the girth strap 18 which is sufficient length to extend around the girth or underbelly of the foal. The girth strap 18 may be made in a similar manner to either the rump strap 14 or the chest strap 16, and may additional include an elastic material to suit varying girths, say, at the locations at which the girth strap 18 is secured to the back pad 12.

The connector strap 20 interconnects a central part of the chest strap 16 to a central part of the girth strap 18, and includes an elasticised portion 34 intermediate its ends to accommodate stretching of the foal's body between the chest strap 16 and girth strap 18. The connector strap 20 also includes male and female buckle components 32, 30. Alternatively, industrial strength hook and loop fasteners (such as that known by the trade mark VELCRO) may be used in place of the buckle components.

As shown in FIG. 3, the spatial arrangement of the straps 14, 16, 18, 20 is such as to maintain the back pad 12 over the desired central area of the back of the foal.

The position of the handle 22 is such as to enable a person to readily grip the handle so as to control and manipulate the foal.

The handle 22 must be durable enough, and sufficiently firmly secured to the back pad, to withstand the kinds of pull or push forces normally encountered when a user is handling a foal. By gripping the handle of the harness, the user can carry out a range of handling or learning experience activities with the foal in a way that does not place the foal under undue stress or the user and the foal under danger of injury.

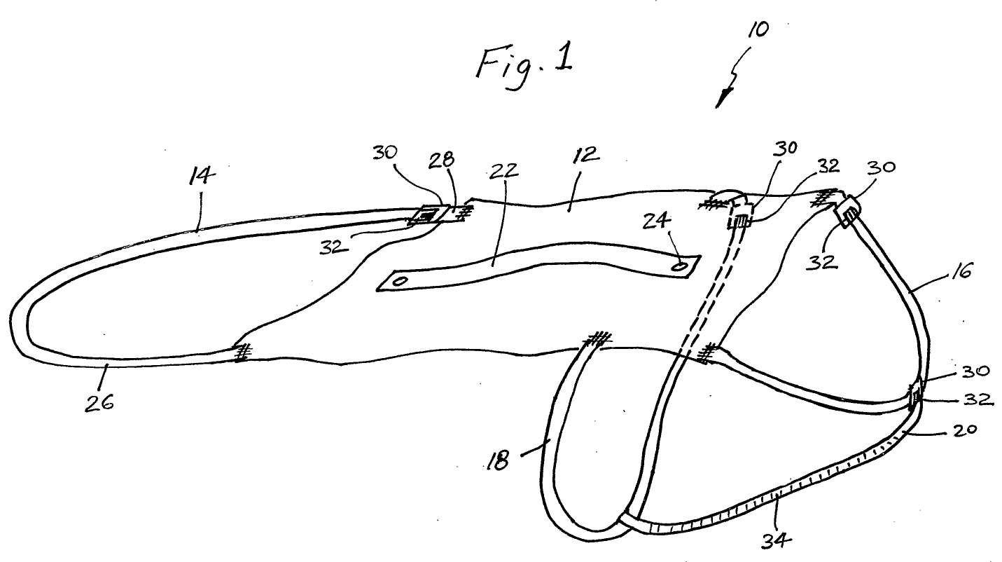

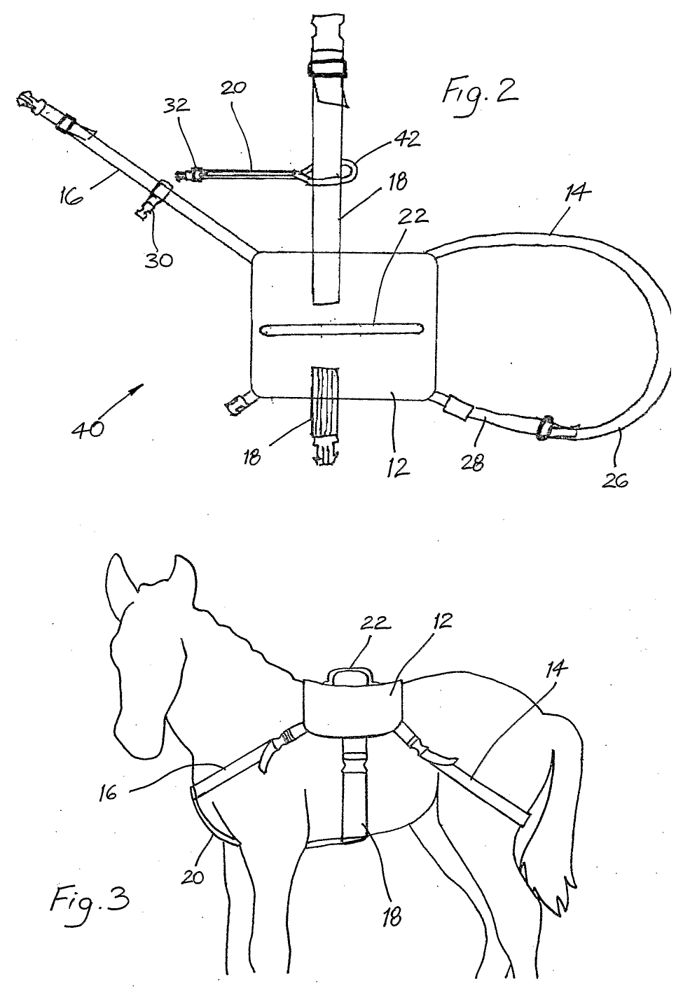

The harness 40 shown in FIG. 2 is similar to the harness 10, and like features are identified with the same numerals used in relation to FIG. 1. The elasticized connector strap 20 is slideably connected to the girth strap 18 by a loop 42 of webbing material, and has a male buckle component 32 connectable to a female buckle component 30 attached to the chest strap 16.

Where a foal or young horse has been successfully handled or “imprinted” with the present invention from birth, handling will be markedly safer and more effective for both the horse and handler. Where the present invention is first used at a later stage of the horse's development as a controlling device only, handling will still be safer and more effective than previous methods.

The present invention, and particularly its feature of the spinal handle, gives the handler the ability to more effectively handle and control the foal during the early stages of its life. The present invention facilitates submission to humans, sensitisation to stimuli and, to a lesser extent, desensitisation to external stimuli, and bonding to humans.

The present invention, and particularly its feature of the spinal handle, also gives the handler a greater ability to physically manipulate the foal by desensitising the foal to the wearing of saddles, girths, breast plates, tail ropes, and harnesses. The spinal handle gives the handler control over the foal whilst, for the foal, the back pad or plate imitates the movements of sideways, backwards, starting, and stopping required by a future rider in the saddle in any equine discipline. Because of its ease of use, the handler utilising the present invention may be an amateur or a professional horse handler, and carry out the handling with safety both to the handler and the foal.

The foregoing is considered as illustrative only of the principles of the invention. Furthermore, since numerous modifications and changes will readily occur to persons skilled in the art, it is not desired to limit the invention to the exact construction and operation shown and described, and accordingly, all suitable modifications and equivalents may be embraced, falling within the scope of the invention.

1. A quadruped animal harness comprising a back pad adapted to be supported at a predetermined position on the back of the quadruped animal, a rump strap connected to a rear end of the pad and adapted to extend around the rump of the quadruped animal, a chest strap connected to a front end of the pad and adapted to extend around the chest of the quadruped animal, a girth strap connected to opposed sides of the pad and adapted to extend around the girth of the quadruped animal, a connector strap interconnecting the chest strap to the girth strap, and a handle connected to the back pad, the arrangement of the straps being such that, in use, the back pad is maintained at the predetermined position to enable a person to control and manipulate the quadruped animal when gripping the handle.

2. The harness of claim 1 wherein the handle is aligned with the spine of the quadruped animal.

3. The harness of claim 1 wherein the girth strap has a first part that is fixedly connected at a first end thereof to one side of the back pad and has a second end thereof to which is connected a first buckle component, the girth strap also having a second part that is elastically connected at a first end thereof to an opposite side of the back pad and has a second end thereof to which is connected a second buckle component, the first and second buckle components being adapted to interengage.

4. The harness of claim 1 wherein the handle is made of flexible material.

5. The harness of claim 1 wherein the handle is made of firm material.

6. The harness of claim 1 wherein the connector strap includes an elasticised portion intermediate its ends to accommodate stretching between the chest strap and the girth strap.
